(19) United States
(12) Patent Application Publication
(10) Pub. No.: US 2017/0070894 A1
(43) Pub. Date: Mar. 9, 2017

(54) THERMAL MITIGATION SYSTEMS AND METHODS FOR MULTI-SUBSCRIPTION DEVICES

(71) Applicant: Qualcomm Incorporated, San Diego, CA (US)

(72) Inventors: Ajeet Kumar, Hyderabad (IN); Ajay K. R. Boddu, Hyderabad (IN); Arun Khanna, Hyderabad (IN); Sabyasachi Bhattacharya, Hyderabad (IN)

(21) Appl. No.: 14/845,836

(22) Filed: Sep. 4, 2015

(51) Int. Cl. H04W 24/02

(52) U.S. Cl. CPC H04W 24/02; H04M 2250/12; H04W 88/02

(57) ABSTRACT

Systems and methods are described herein for performing thermal mitigation in a mobile communication device having a first subscription and a second subscription. The method includes, but not limited to, determining whether the mobile communication device has reached a first thermal level in which only circuit switching services are available, detecting that the second subscription is out of service in response to determining that the mobile communication device has reached the first thermal level, determining whether a current temperature exceeds, beyond a threshold, a temperature at a time of a previous scan for an available network for the second subscription, and waiting a first period of time before scanning for the available network for the second subscription, in response to determining that the current temperature exceeds, beyond the threshold, the temperature at the time of the previous scan.

### BACKGROUND

A mobile communication device, such as a mobile phone, may include a plurality of subscriber identity modules (SIMs). For example, when all SIMs in a multi-SIM mobile communication device are active, the device may be a multi-SIM-multi-active (MSMA) communication device. When one SIM in a multi-SIM mobile communication device is active while the rest of the SIM(s) is standing by, the device may be a multi-SIM-multi-standby (MSMS) communication device. Each SIM may be provided a subscription to a radio access technology (RAT), such as, but not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network.

As mobile communication devices including circuits, components, and subsystems are packed into smaller form factors, while also being configured to perform more functions, heat management has become increasingly relevant, especially for multi-subscription devices in which more than one receive/transmit subsystems reside in a single device. Elevated temperature can cause malfunctions of and damages to mobile communication devices. Conventional thermal mitigation solutions include reducing transmission power for one or more subscriptions of the mobile communication device, slowing logic clock cycles of one or more subscription, and disabling data calls.

### SUMMARY

Embodiments described herein relate to efficient thermal mitigation systems and methods for multi-subscription mobile communication devices. For example, a method for performing thermal mitigation in a mobile communication device having a first subscription and a second subscription comprises determining whether the mobile communication device has reached a first thermal level in which only circuit switching services are available, detecting that the second subscription is out of service in response to determining that the mobile communication device has reached the first thermal level, determining whether a current temperature exceeds, beyond a threshold, a temperature at a time of a previous scan for an available network for the second subscription, and waiting a first period of time before scanning for the available network for the second subscription, in response to determining that the current temperature exceeds, beyond the threshold, the temperature at the time of the previous scan.

In some embodiments, waiting the first period of time comprises waiting until the current temperature does not exceed, beyond the threshold, the temperature at the time of the previous scan.

In some embodiments, the method further comprises scanning for the available network for the second subscription in response to determining that the temperature after waiting the first period of time does not exceed, beyond the threshold, the temperature at the time of the previous scan.

In various embodiments, the method further comprises determining that the available network has been found, and connecting the second subscription to the available network.

In some embodiments, the method further comprises determining that the available network has not been found, and waiting a second period of time before scanning for the available network for the second subscription.

In various embodiments, scanning for the available network comprises scanning a frequency band for detecting a broadcast signal transmitted by a base station of the available network.

According to some embodiments, the first period of time is a predefined period of time.

According to various embodiments, the first period of time changes dynamically over time.

According to some embodiments, the first period of time is based, at least in part, on a type of the mobile communication device or parameters thereof.

According to various embodiments, the first period of time is based, at least in part, on a component or a thermal zone for which the current temperature exceeds, beyond the threshold, the temperature at the time of the previous scan.

In some embodiments, the method further comprises determining whether a difference between the current temperature of the mobile communication device and a second thermal level in which only emergency services are available is below an amount, selecting the first subscription as a priority subscription, and shutting down the second subscription, but not the first subscription, in response to determining that the difference is below the amount.

In various embodiments, shutting down the second subscription comprises shutting down a radio frequency (RF) resource dedicated to use by the second subscription.

In some embodiments, shutting down the second subscription comprises stopping assigning time slots of a radio frequency (RF) resource for the second subscription, wherein the RF resource is shared by the first subscription and the second subscription based on time slots already assigned.

In some embodiments, the method further comprises determining whether the current temperature has dropped to a predefined level, after shutting down the second subscription; and reactivating the second subscription in response to determining that the current temperature has dropped to the predefined level.

In various embodiments, the previous scan is a last scan for the available network for the second subscription before determining the current temperature.

According to some embodiments, a mobile communication device having a first subscription and a second subscription comprises at least one radio frequency (RF) resource, one or more processors coupled to the RF resource and configured with processor-executable instructions to: determine whether the mobile communication device has reached a first thermal level in which only circuit switching services are available, detect that the second subscription is out of service in response to determining that the mobile communication device has reached the first thermal level, determine whether a current temperature exceeds, beyond a threshold, a temperature at a time of a previous scan for an available network for the second subscription, and wait a first period of time before scanning for the available network for the second subscription, in response to the determining that the current temperature exceeds, beyond the threshold, the temperature at the time of the previous scan.

In various embodiments, the mobile communication device further comprises one or more thermal sensors communicably coupled to the one or more processors, wherein the one or more thermal sensors are configured to detect the current temperature of at least a portion of the mobile communication device.

In some embodiments, the one or more processors are further configured with processor-executable instructions to scan for the available network for the second subscription in response to determining that the temperature after waiting the first period of time does not exceed, beyond the threshold, the temperature at the time of the previous scan.

In various embodiments, the one or more processors are further configured with processor-executable instructions to: determine whether the available network has been found, connect the second subscription to the available network, in response to determining that the available network has been found, and wait a second period of time before scanning for the available network for the second subscription, in response to determining that the available network has not been found.

According to various embodiments, a method for performing thermal mitigation in a mobile communication device having a first subscription and a second subscription comprises determining whether the mobile communication device has reached a first thermal level in which only circuit switching services are available, determining whether a difference between a current temperature of the mobile communication device and a second thermal level in which only emergency services are available is below an amount, in response to determining that the mobile communication device has reached the first thermal level; selecting the first subscription as a priority subscription; and shutting down the second subscription, but not the first subscription, in response to determining that the difference is below the amount.

In some embodiments, selecting the first subscription as the priority subscription comprises receiving a user input from the mobile communication device corresponding to a user's selection of the first subscription as the priority subscription.

In various embodiments, shutting down the second subscription comprises shutting down a radio frequency (RF) resource dedicated to use by the second subscription.

In some embodiments, shutting down the second subscription comprises stopping assigning time slots of a radio frequency (RF) resource for the second subscription, wherein the RF resource is shared by the first subscription and the second subscription based on time slots already assigned.

According to various embodiments, the method further comprises determining whether the current temperature has dropped to a predefined level, after shutting down the second subscription, and reactivating the second subscription in response to determining that the current temperature has dropped to the predefined level.

According to some embodiments, reactivating the second subscription comprises reactivating a radio frequency (RF) resourced dedicated to use by the second subscription.

According to various embodiments, reactivating the second subscription comprises starting to assign time slots of a radio frequency (RF) resource for the second subscription, wherein the RF resource is shared by the first subscription and the second subscription based on time slots already assigned.

In some embodiments, a mobile communication device having a first subscription and a second subscription comprises at least one radio frequency (RF) resource, and one or more processors coupled to the RF resource and configured with processor-executable instructions to: determine whether the mobile communication device has reached a first thermal level in which only circuit switching services are available, whether a difference between a current temperature of the mobile communication device and a second thermal level in which only emergency services are available is below an amount, in response to determining that the mobile communication device has reached the first thermal level, select the first subscription as a priority subscription; and shut down the second subscription, but not the first subscription, in response to determining that the difference is below the amount.

In various embodiments, the mobile communication device further comprises one or more thermal sensors communicably coupled to the one or more processors, wherein the one or more thermal sensors are configured to detect the current temperature of at least a portion of the mobile communication device.

In some embodiments, the one or more processors are further configured with processor-executable instructions to shut down the second subscription comprises shutting down a radio frequency (RF) resource dedicated to use by the second subscription.

In various embodiments, the one or more processors are further configured with processor-executable instructions to stop assigning time slots of a radio frequency (RF) resource for the second subscription, wherein the RF resource is shared by the first subscription and the second subscription based on time slots already assigned.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a mobile communication device according to various embodiments.

FIG. 3A is a process flowchart diagram illustrating an example of a thermal mitigation method according to various embodiments.

FIG. 3B is a process flowchart diagram illustrating an example of a thermal mitigation method according to various embodiments.

FIG. 4A is a process flowchart diagram illustrating an example of a thermal mitigation method according to various embodiments.

FIG. 4B is a process flowchart diagram illustrating an example of a thermal mitigation method according to various embodiments.

FIG. 4C is a process flowchart diagram illustrating an example of a thermal mitigation method according to various embodiments.

FIG. 5 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a mobile communication device or mobile station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such devices may include at least one SIM, a programmable processor, memory, and circuitry for connecting to two or more mobile communication networks simultaneously.

A mobile communication device may include one or more subscriber identity modules (SIMs) that provide users of the device with access to one or multiple separate mobile communication networks. The mobile communication networks are supported by radio access technologies (RATs). Examples of mobile communication devices include, but are not limited to, mobile phones, laptop computers, smart phones, and other mobile communication devices or the like that are configured to connect to one or more RATs. Examples of RATs include, but are not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network.

A mobile communication device provided with a plurality of SIMs and connected to two or more separate (or same) RATs using a same set of transmission hardware (e.g., radio-frequency (RF) transceivers) is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a mobile communication device that includes a plurality of SIMs and connects to two or more separate (or same) RATs using two or more separate sets of transmission hardware is termed a multi-SIM-multi-active (MSMA) communication device. An example MSMA communication device is a dual-SIM-dual-active (DSDA) communication device, which includes two SIM cards/subscriptions. Both SIMs may remain active. In another example, the MSMA device may be a triple-SIM-triple-active (TSTA) communication device, which includes three SIM cards/subscriptions. All three SIMs may remain active. In other examples, the MSMA communication device may be other suitable multi-SIM communication devices with four or more SIMs, for which that all SIMs may be active.

Embodiments described herein relate to a multi-SIM context, such as, but not limited to, the MSMS and MSMA contexts. For example, in the multi-SIM context, each subscription may be configured to acquire service from a base station (associated with a given cell).

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Referring generally to the figures, embodiments described herein relate to thermal mitigation for multi-SIM mobile communication devices, such as, but not limited to MSMA and MSMS communication devices. For clarity, systems and processes described refer to a mobile communication device with two subscriptions. However, a multi-SIM mobile communication device with three or more subscriptions may implement systems and methods described in similar manners. In particular embodiments, thermal mitigation is implemented by taking one or more measures to reduce heat generation per subscription based on one or more different thermal levels (i.e., temperature) reached by the mobile communication device. For example, if a first thermal threshold is reached, the mobile communication device may enter a first thermal mitigation state where, for example, a receive/transmission data rate is reduced. If the temperature of the mobile communication device keeps rising and a second thermal threshold is reached, the mobile communication device may enter a second thermal mitigation state where, for example, streaming traffic (for example but not limited to, video streaming, audio streaming, etc.) may be disabled while other browsing traffic may be allowed. If the temperature of the mobile communication device keeps rising beyond the second thermal threshold and a third thermal threshold is reached, the mobile communication device may enter a third thermal mitigation state where, for example, data services may be disabled while voice calls are allowed. If yet another thermal threshold beyond the third thermal threshold is reached, the mobile communication device may enter a fourth thermal mitigation state, for example, in which all services are disabled except emergency communications.

In particular embodiments, the actions taken in each thermal mitigation state may be predefined actions selected to reduce the temperature or minimize further increases in the temperature of the mobile communication device, and may include the above-noted examples or other selected actions. While the above embodiment includes four thermal thresholds and four thermal mitigation states, other embodiments may employ one, two, three or more than four thermal thresholds and corresponding thermal mitigation states, each having one or more defined actions to take. In particular embodiments, as each further thermal threshold is reached, the actions taken in response to the mobile communication device reaching the previous thermal threshold continue to be taken, while additional actions associated with the further thermal threshold are also taken. In other embodiments, as each further thermal threshold is reached, the actions taken in response to the mobile communication device reaching the previous thermal threshold are no longer taken and, instead, the actions associated with the further thermal threshold are taken.

Typically, if one of the subscriptions (SUB 1) of a multi-subscription mobile communication device is in service while the other (SUB 2) is out of service, SUB 2 will aggressively scan for available networks for a CS connection. This can occur, even when the mobile communication device reaches the thermal level where only circuit switching (CS) service, i.e., voice calls, is available. The aggressive scan can cause a further temperature rise and consume battery life very quickly. Therefore, according to embodiments disclosed herein, an intelligent scan is performed. In particular, the decision of whether to conduct a scan by SUB 2 is based, at least in part, on a temperature change of the mobile communication device. According to some embodiments, a current temperature of the mobile communication device may be compared to the temperature of the mobile communication device at a time of a previous scan. If the current temperature exceeds the temperature at the time of the previous scan by an amount beyond a threshold, a scan by SUB 2 for available networks will not occur. The temperature may be checked again after a period of time. In some implements, the previous scan may be the last scan immediately before the temperature check. If the current temperature has not risen to exceed the temperature of the previous scan beyond the threshold, SUB 2 may scan for available networks for a CS connection. If the connection is found, SUB 2 may be camped. If an available network has not been found, the temperature may be checked again after a period of time. According to further respective embodiments, the period of time between temperature checks can be preset, can change dynamically over time, can be based on the type of the mobile communication device or parameters thereof, or can be based on a component or thermal zone for which the current temperature is high.

Various embodiments relate to a situation in which a multi-subscription mobile communication device enters the thermal level where only circuit switching (CS), i.e., voice calls, is available and both subscriptions (SUB 1 and SUB 2) are having CS services. According to such embodiments, one subscription (SUB 1) is selected to be the priority subscription and the other subscription (SUB 2) is the non-priority subscription. When a difference between a current temperature and a next thermal level in which only limited services are provided is below a predefined amount, the non-priority subscription SUB 2 may be shut down. In further embodiments, after SUB 2 is shut down, if the current temperature of the mobile communication device drops to a safe level (e.g., below that or another predefined temperature threshold), SUB 2 may be reactivated.

In various embodiments, the user may designate one subscription to be of higher priority than another, for example, by manual selection or by automated selection based on user preferences or behavior over time. In various embodiments, the selection of the priority SUB is made automatically based on channel quality metrics for each of the subscriptions. In embodiments in which the mobile communication device has more than two subscriptions having CS services, all subscriptions not selected as the priority subscription (SUB 1) are non-priority subscriptions. In further embodiments in which the mobile communication device has more than two subscriptions having CS services, all subscriptions or all subscriptions not selected as the priority subscription (SUB 1) are associated with different respective priority levels and the subscriptions are shut down in an order corresponding to their priority levels, where a different subscription is shut down as each next thermal level is reached.

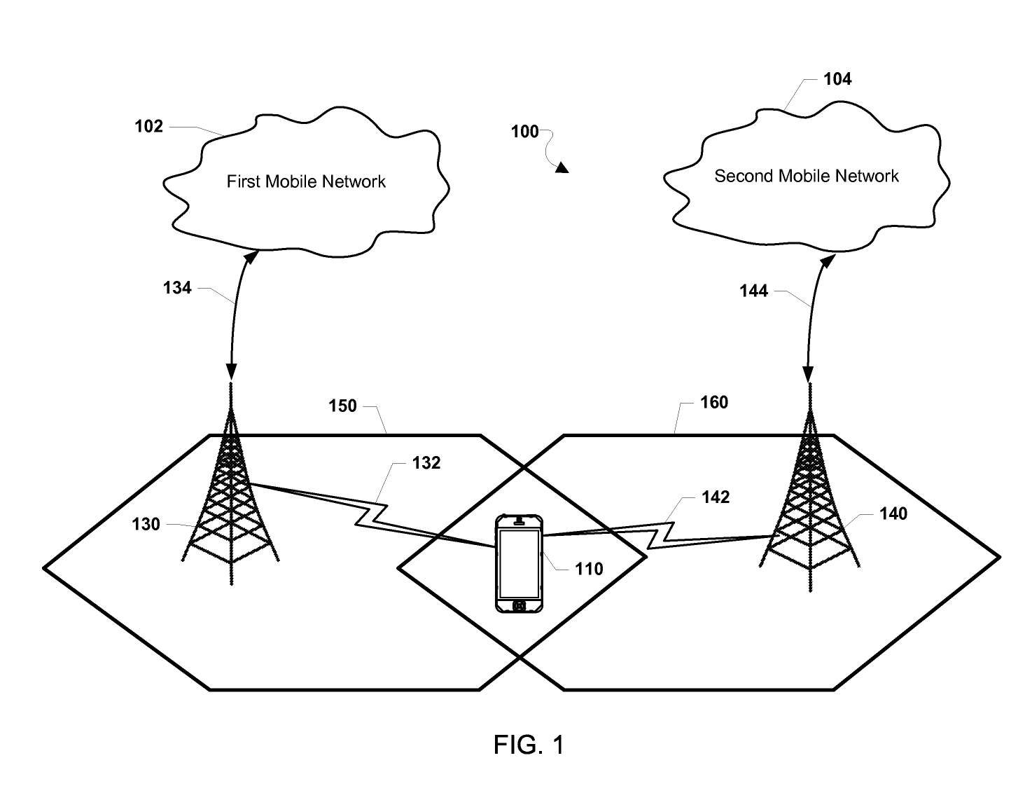

Various embodiments may be implemented within a communication system 100, an example of which is illustrated in FIG. 1. A first mobile network 102 and a second mobile network 104 typically each include a plurality of cellular base stations (for example but not limited to, a first base station 130 and a second base station 140). The first base station 130 may broadcast the first mobile network 102 in a first serving cell 150. The second base station 140 may broadcast the second mobile network 104 in a second serving cell 160. mobile communication device 110 may acquire cell service from either the first serving cell 150 or the second serving cell 160, or both.

The mobile communication device 110 may be in communication with the first mobile network 102 through a first cellular connection 132 to the first base station 130. The first cellular connection 132 may correspond to a first subscription (SUB 1) of the mobile communication device 110. The device 110 may also be in communication with the second mobile network 104 through a second cellular connection 142 to the second base station 140. The second cellular connection 142 may correspond to a second subscription (SUB 2) of the device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enabled by FDMA, TDMA, CDMA, UMTS (particularly, WCDMA, LTE, and the like), GSM, GPRS, Wi-Fi, PCS, or another protocol used in a wireless communications network or a data communications network. By way of illustrating with a non-limiting example, the first cellular connection 132 may be a WCDMA subscription and the second cellular connection 142 may be a GSM subscription. While WCDMA and GSM may be used as non-limiting examples herein as the first subscription and the second subscription, one or ordinary skill in the art would appreciate that embodiments concerning other RATs (e.g., LTE, EVDO, 1×, and the like) may be implemented in a similar manner. In some embodiments, the first cellular connection 132 and the second cellular connections 142 may each be associated with a different RAT. In other embodiments, the first connection 132 and the second cellular connection 142 may be associated with a same RAT.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNode B or eNB), base transceiver station (BTS), or the like.

In various embodiments, the mobile communication device 110 may be configured to access the first mobile network 102 and the second mobile network 104 by virtue of the multi-SIM and/or the multi-mode SIM configuration of the device 110 (e.g., via the first cellular connection 132 and the second cellular connection 142). When a SIM corresponding to a subscription is received, the device 110 may access the mobile communication network associated with that subscription based on the information stored on the SIM.

While the mobile communication device 110 is shown connected to the mobile networks 102 and 104 via two cellular connections, in some embodiments (not shown), the device 110 may establish additional cellular connections associated with additional subscriptions corresponding to the mobile networks 102 and 104 in a manner similar to those described above.

In some embodiments, the mobile communication device 110 may establish a wireless connection with a peripheral device (not shown) used in connection with the mobile communication device 110. For example, the mobile communication device 110 may communicate over a Bluetooth® link with a Bluetooth-enabled personal computing device (e.g., a “smart watch”). In some embodiments, the mobile communication device 110 may establish a wireless connection with a wireless access point (not shown), such as over a Wi-Fi connection. The wireless access point may be configured to connect to the Internet or another network over a wired connection.

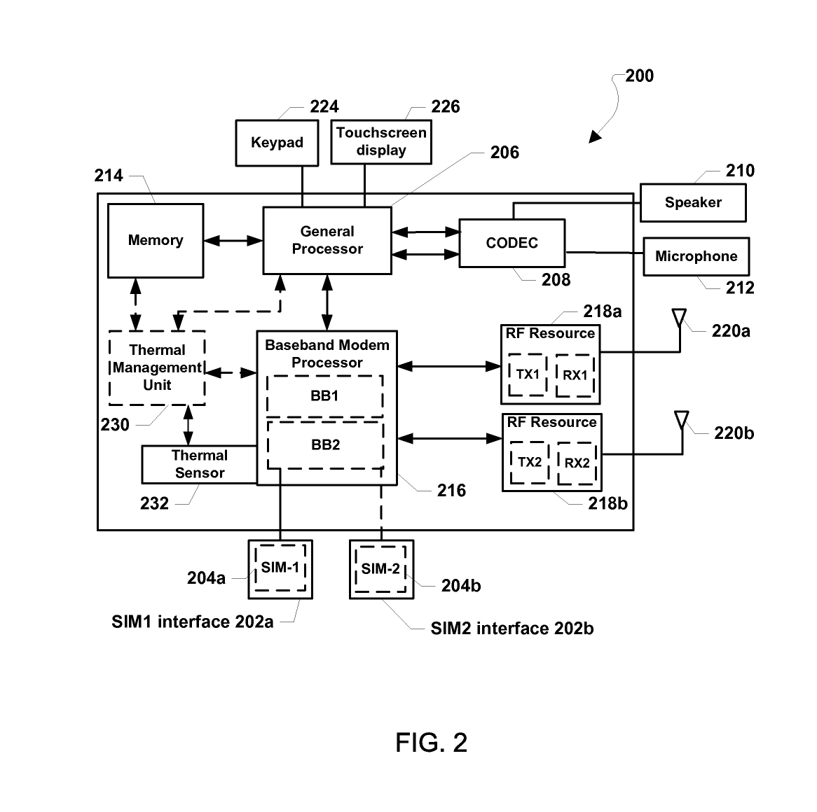

FIG. 2 is a functional block diagram of an mobile communication device 200 suitable for implementing various embodiments. According to various embodiments, the mobile communication device 200 may be the mobile communication device 110 as described with reference to FIG. 1. Referring to FIGS. 1-2, the mobile communication device 200 may include a first SIM interface 202a, which may receive a first identity module SIM-1 204a that is associated with the first subscription (SUB 1). The mobile communication device 200 may also include a second SIM interface 202b, which may receive a second identity module SIM-2 204b that is associated with the second subscription (SUB 2).

A SIM in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device 200, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The mobile communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a digital signal processor (DSP) and a microprocessor, a plurality of microprocessors, at least one microprocessors in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, random access memory RAM, read only memory ROM, floppy disks, hard disks, dongles or other recomp sensor board (RSB) connected memory devices, or the like. The memory 214 may store an operating system (OS), user application software, and/or executable instructions. The memory 214 may also store application data, such as an array data structure.

The general-purpose processor 206 and the memory 214 may each be coupled to at least one baseband modem processor 216. Each SIM in the mobile communication device 200 (e.g., the SIM-1 202a and the SIM-2 202b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources 218a, 218b (e.g., the first RF resource 218a and the second RF resource 218b). In some embodiments, baseband-RF resource chains may share the baseband modem processor 216 (i.e., a single device that performs baseband/modem functions for all SIMs on the mobile communication device 200). In other embodiments, each baseband-RF resource chain may include physically or logically separate baseband processors (e.g., BB1, BB2). Alternatively, one baseband-RF resource chain may be shared by two or more of the RATs enabled by the SIMs 204a, 204b. For example, but not limited, the SIMs 204a and 204b may share a single RF resource instead of utilizing separated RF resources 218a dedicated to use by SIM 204a and 218b dedicated to use by SIM 204b. The SIMs 204a and 204 b may utilize the RF resource at time slots assigned thereto. The assigned time slots may be fixed or based on demand.

The RF resources 218a, 218b may each be transceivers that perform transmit/receive functions for the associated SIMs 204a, 204b of the mobile communication device 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

For simplicity, the first RF resource 218a (as well as the associated components) may be associated with the first subscription (SUB 1) as enabled by the SIM-1 202a. For example, the first RF resource 218a may be configured to transmit/receive data via the first cellular connection 132. The second RF resource 218b may be associated with the second subscription (SUB 2) as enabled by the SIM-2 202b. For example, the second RF resource 218b may be configured to transmit/receive data via the second cellular connection 142. In the embodiments in which a single RF resource is shared by SUB 1 and SUB 2, the RF resource may be configured to transmit/receive data via the first cellular connection 132 in time slots assigned to SUB 1 and to transmit/receive data via the second cellular connection 142 in time slots assigned to SUB 2.

In some embodiments, the general-purpose processor 206, the memory 214, the baseband modem processor(s) 216, and the RF resources 218a, 218b may be included in the mobile communication device 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

In some embodiments (not shown), the mobile communication device 200 may include, among other things, additional SIM cards, SIM interfaces, a plurality of RF resources associated with the additional SIM cards, and additional antennae for connecting to additional mobile networks.

The mobile communication device 200 may include a thermal sensor 232, which may be disposed on or in sufficient proximity to the baseband modem processor 216 or other suitable location in the mobile communication device 200, to detect the real-time temperature of the baseband modem processor 216. The thermal sensor 232 may be coupled to a thermal management unit 230 and may transmit data of the real-time temperature to the thermal management unit 230. In some embodiments, the thermal sensor 232 may be disposed on or in sufficient proximity of another component of the mobile communication device 200 to detect the real-time temperature of that component, for example, but not limited to the memory 214, the general processor 206, the CODEC 208, and/or the RF resources 218a, 218b. In some embodiments, the thermal sensor 232 may be disposed on or in sufficient proximity of a predetermined thermal zone that includes a group of components. In some embodiments, there may be more than one thermal sensors 232, each detecting the real-time temperature of a respective component or a respective thermal zone of the mobile communication device 200. The thermal sensor 232 may be any suitable sensor that can detect or measure a thermal indicator, such as, but not limited to a thermistor. In alternative embodiments, instead of being a separate component, a thermistor (or the like) used as the thermal sensor 232 may be integrated into the circuitry of the baseband modem processor 216 or other component for which temperature is detected.

The thermal management unit 230 is configured to manage and/or schedule utilization of the RF resources 218a, 218b for thermal mitigation processes. For example, the thermal management unit 230 may be configured to perform thermal processes for the first subscription (SUB 1) and the second subscription (SUB 2), in the manner described herein.

In some embodiments, the thermal management unit 230 may be implemented within the general-purpose processor 206. For example, the thermal management unit 230 may be implemented as a software application stored within the memory 214 and executed by the general-purpose processor 206. Accordingly, such embodiments can be implemented with minimal additional hardware costs. However, other embodiments relate to systems and process that are implemented with dedicated device hardware specifically configured for performing operations described herein. For example, the thermal management unit 230 may be implemented as a separate hardware component (i.e., separate from the general-purpose processor 206). The thermal management unit 230 may be coupled to the memory 214, the general processor 206, and/or the baseband modem processor 216 for performing the function described herein. The thermal management unit 230 may include (or coupled to) at least one of a radio resource control (RRC) layer, a radio resource management (RR) layer, a radio link control (RLC) layer, a media access control (MAC) layer, a physical layer, and the like.

Hardware and/or software for the functions may be incorporated in the mobile communication device 200 during manufacturing, for example, as part of a configuration of an original equipment manufacturer (“OEM”) of the mobile communication device 200. In further embodiments, such hardware and/or software may be added to the mobile communication device 200 post-manufacture, such as by installing one or more software applications onto the mobile communication device 200.

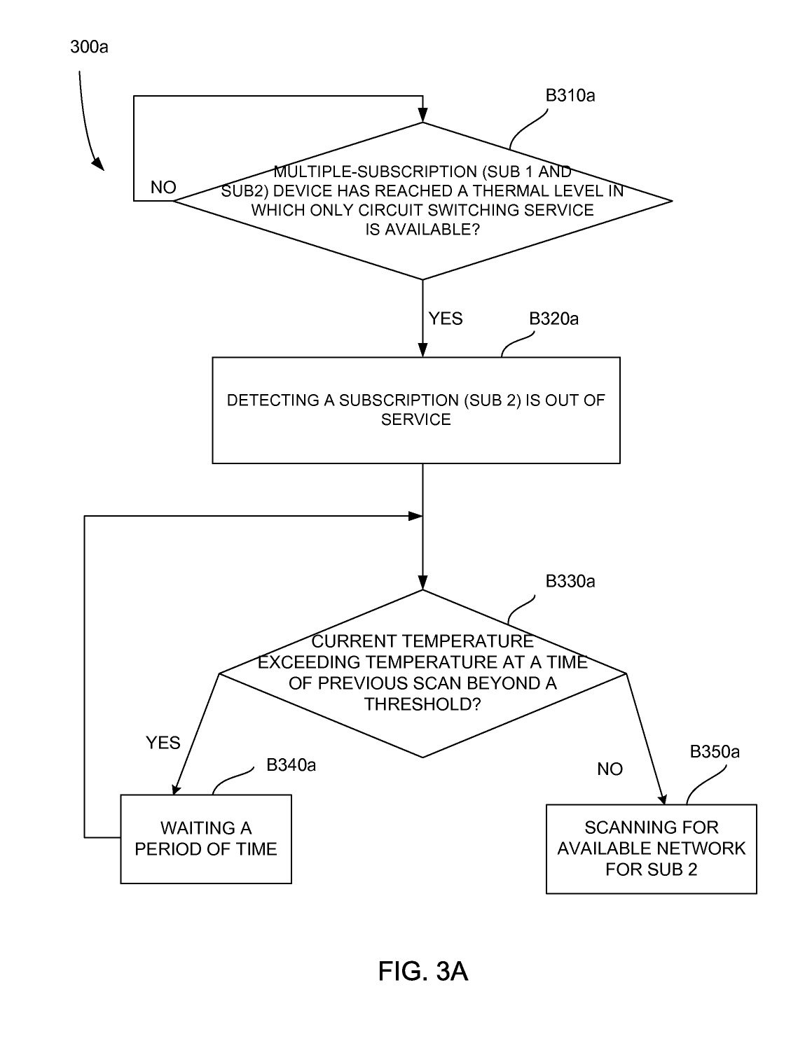

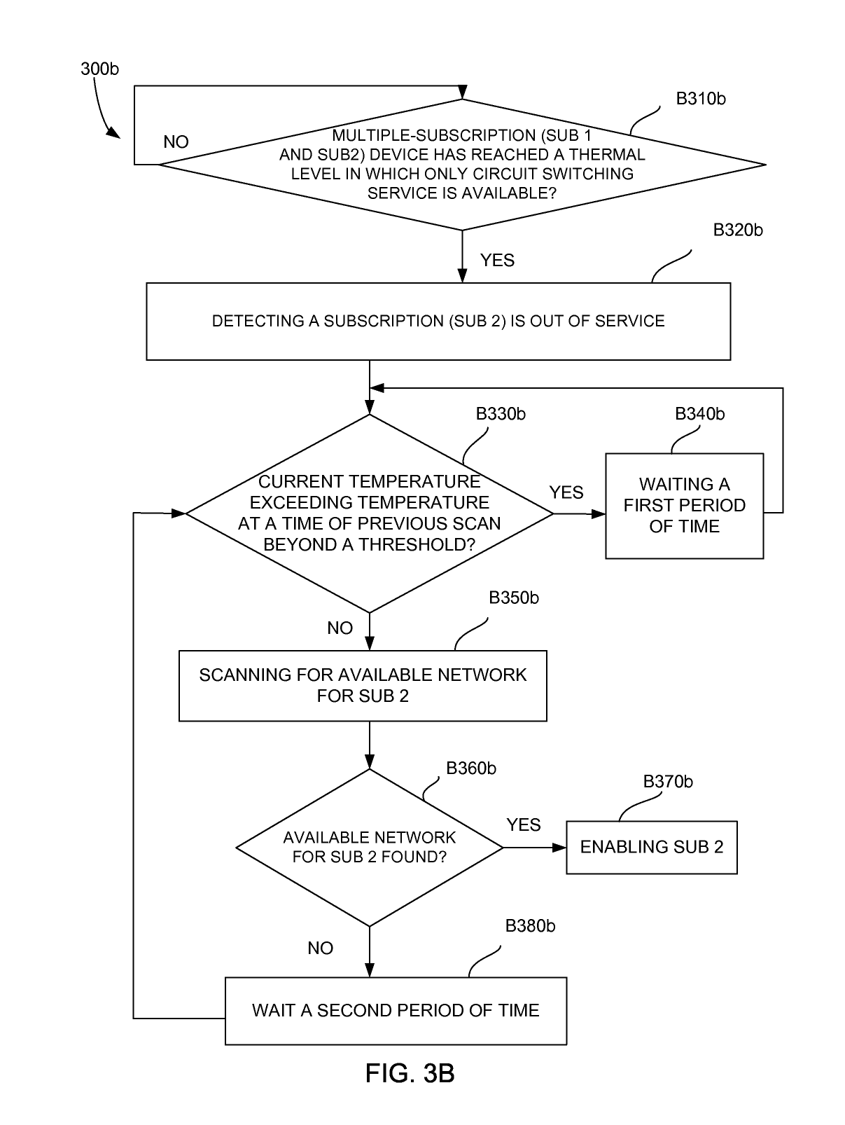

FIG. 3A is a process flowchart diagram illustrating an example of a thermal mitigation method 300a according to various embodiments. Referring to FIGS. 1-3A, the thermal mitigation method 300a may be performed by the thermal management unit 230 of the mobile communication device 200 according to some embodiments.

At block B310a, the thermal management unit 230 may be configured to determine whether the multi-subscription mobile communication device 200 has reached a thermal level in which only circuit switching (CS) service is available. As discussed above, the thermal management unit 230 may be coupled to the thermal sensor 232 and receive from the thermal sensor 232 data indicating the real-time temperature of the baseband modem processor 216 and/or other components of the mobile communication device 200. The thermal management unit 230 may enable a graduated approach to thermal mitigation per subscription based on the received real-time temperature data. There may be, for example but not limited to, four (4) thermal levels in ascending order 1-4. If the real-time temperature reaches a first threshold for a first thermal level, the thermal management unit 230 may instruct the RF resources 218a, 218b to take a first predefined action, for example but not limited to, reduce transmission data rate and/or slow processing clock cycle for each subscription, to reduce heat generation.

The thresholds for the thermal levels may vary for different components. For example, but not limited, the baseband modem processor 216 may have an operating temperature tolerance between −40° C. and +125° C. The memory 214 may have an operating temperature tolerance between 0° C. and +70° C. Therefore, the threshold for the first thermal level of the baseband modem processor 216 may be different from that of the memory 214. In some embodiments, the thresholds for the thermal levels may be chosen with multiple components of different temperature tolerance being considered.

If the real-time temperature reaches a second threshold for a second thermal level, the thermal management unit 230 may instruct the RF resources 218a, 218b to take a second predefined action, for example but not limited to, disable streaming data traffic (such as but not limited to, video streaming, audio streaming, etc.) while allowing non-streaming data traffic, to reduce heat generation.

If the real-time temperature reaches a third threshold for a third thermal level, the thermal management unit 230 may instruct the RF resources 218a, 218b to take a third predefined action, for example but not limited to, disable data calls while only allow voice calls, to reduce heat generation. In some embodiments, a data call (such as but not limited to, a packet data call) may use packet switching (PS) technology (e.g., GPRS). By comparison, a voice call may use a circuit switching (CS) technology. Data calls may be disabled first because data calls can be more power hungry than voice calls.

If the real-time temperature hits a fourth threshold for a fourth thermal level, the thermal management unit 230 may instruct the RF resources 218a, 218b to take a fourth predefined action, for example but not limited to, disable all services except emergency communications (e.g., “911”).

If the mobile communication device 200 has reached the thermal level in which only circuit switching services are available (such as, but not limited to, a third thermal level as discussed above), the thermal management unit 230 may instruct the baseband modem 216 (or other component) to disable data calls, while allowing voice calls only. Thus, in particular embodiments, actions associated with lower thermal level(s) (such as, but not limited to a first and second thermal levels discussed above) had already been taken, but the temperature continued to rise to hit the current thermal level. If the temperature keeps rising, the mobile communication device 200 might reach a higher thermal level (such as, but not limited to, a fourth thermal level as discussed above.)

While a four-thermal-level scheme is described in particular example embodiments, other embodiments may employ one, two, three or more than four thermal levels (or temperature thresholds) and associated predefined actions, where the method 300a corresponds to the actions taken in response to reaching one of those levels. Also, while examples of particular actions taken at each respective thermal level are described according to particular embodiments, in other embodiments, other suitable predefined actions may be taken at any one or more of the thermal levels. In particular embodiments, as each next thermal threshold is reached, the actions taken in response to the mobile communication device reaching each lower thermal threshold continue to be taken, while additional actions associated with that next thermal threshold are also taken. In other embodiments, as each next thermal threshold is reached, the actions taken in response to the mobile communication device reaching each (or at least one) lower thermal threshold are no longer taken and, instead, the actions associated with that next thermal threshold are taken.

Thus in response to determining that the mobile communication device 200 has not reached the thermal level (B310a: NO), the thermal management unit 230 may keep checking the temperature. In response to determining that the mobile communication device 200 has reached the thermal level (B310a: YES), the baseband modem process 216 detects or otherwise determines that a subscription (e.g., SUB 2) is out of service, at block B320a. In particular, the second RF resource 218b may be associated with the second subscription (SUB 2) as enabled by the SIM-2 202b. When SUB 2 is “in service,” the second RF resource 218b receives the broadcast signals transmitted by the second base station 140, establishes the second cellular connection 142 with the second base station 140, and connects the mobile communication device 200 to the second mobile work 104 through the second base station 140. If the second RF resource 218b is not able to receive the broadcast by the second base station 140 or otherwise fails to establish the second cellular connection 142, then SUB 2 is “out of service.” Reasons may be, for example but not limited to that, the second base station 140 is busy, out of range or otherwise unavailable.

Next, at block B330a, the thermal management unit 230 determines whether a current temperature (e.g., as detected by the thermal sensor 232) exceeds, beyond a threshold, a temperature of the mobile communication device 200 at a time of a previous scan. In some implements, the previous scan may be the last scan for an available network for SUB 2 immediately before the temperature check. When SUB 2 is out of service, the second RF resource 218b scans a frequency band for detecting signals being transmitted to try to find the broadcast signals transmitted by the second base station 140. If the SUB 2 broadcast signals are not found and the second RF resource 218b keeps scanning for the second base station 140, such aggressive scanning can exacerbate the thermal condition.

However, according to particular embodiments, for every round (or selected rounds) of scanning after the first scan, the thermal management unit 230 may first determine whether the current temperature exceeds, beyond the threshold, the detected temperature at the time of the previous scan. The current temperature may be received from the thermal sensor 232. The temperature at the time of the previous scan may be stored in the memory 214. In particular embodiments, each time that another round of scanning occurs, the temperature at that round may be stored in place of the temperature at the time of the previous scan stored in the memory 214. The threshold may be predefined to be any suitable value, such as, but not limited to, 0.5 Celsius degrees. The threshold may vary for the mobile communication device 200 with different chipsets.

When the thermal management unit 230 determines that the current temperature exceeds, beyond the threshold, the temperature at the time of the previous scan (B330a: YES), the thermal management unit 230 may instruct the second RF resource 218b to wait a period of time, at block B340a. In one example, the period of time of waiting may be, for example, but not limited to, 30 seconds. In another example, the period of time may change dynamically over time. For example, as more scans are performed, the period of time of waiting may be lengthened. In yet another example, the period of time may be based on the type of mobile communication device 200 and/or parameters thereof. For example, a longer period of waiting time may be applied for a mobile communication device having a smaller dimension. In still another example, the period of time may be based on the component or thermal zone for which the temperature is high. For example, different periods of time may be applied to a situation in which the temperature of the memory 214 is high and a situation in which the temperature of the baseband modem processor 216 is high.

After the period of time, the thermal management unit 230, at block B330a, may again determine whether the current temperature exceeds, beyond the threshold, the temperature at the time of the previous scan. On the other hand, when the thermal management unit 230 determines that the current temperature does not exceed, beyond the threshold, the temperature at the time of the previous scan (B330a: NO), the thermal management unit 230 may instruct the second RF resource 218b to perform another round of scan for broadcast signals transmitted by the second base station 140, at block B350a.

FIG. 3B is a process flowchart diagram illustrating an example of a thermal mitigation method 300b according to various embodiments. Referring to FIGS. 1-3B, the thermal mitigation method 300b may be performed by the thermal management unit 230 of the mobile communication device 200 according to some embodiments.

At block B310b, the thermal management unit 230 may determine whether the multi-subscription mobile communication device 200 has reached a thermal level where only circuit switching (CS) service is available. Thus in response to determining that the mobile communication device 200 has not reached the thermal level (B310b: NO), the thermal management unit 230 may keep checking the temperature. In response to determining that the mobile communication device 200 has reached the thermal level (B310b: YES), the baseband modem process 216 may determine that a subscription (e.g., SUB 2) is out of service, at block B320b. Next, at block B330b, the thermal management unit 230 may determine whether a current temperature exceeds, beyond a threshold, a temperature at a time of a previous scan. In response to determining that the current temperature exceeds, beyond the threshold, the temperature at the time of the previous scan (B330b: YES), the thermal management unit 230 may instruct the second RF resource 218b to wait a first period of time, at block B340b. After the first period of time, the thermal management unit 230 may, again, determine whether the current temperature exceeds, beyond the same or other predetermined threshold, the temperature at the time of the previous scan, at block B330b. On the other hand, in response to determining that the current temperature does not exceed, beyond the threshold, the temperature at the time of the previous scan (B330: NO), the thermal management unit 230 may instruct the second RF resource 218b to perform another round of scanning for broadcast signals transmitted by the second base station 140, at block B350b.

Next, at block B360b, the baseband modem processor 216 may determine whether or not the second RF resource 218b has found an available network for SUB 2 during the scan. In particular, if the second RF resource 218b has received broadcast signals transmitted by the second base station 140, then the baseband modem processor 216 may determine that the available network has been found for SUB 2.

In response to determining that the available network has been found for SUB 2 (B360b: YES), the baseband modem processor 216 may establish the second cellular connection 142 between the mobile communication device 200 and the second base station 140 that allows voice calls for SUB 2, at block B370b. In response to determining that the available network has not been found for SUB 2 (B360b: NO), the thermal management unit 230 may instruct the second RF resource 218b to wait a second period of time, at block B380b. After the second period of time, the thermal management unit 230 may again determine whether the current temperature exceeds the temperature of the previous scan beyond the threshold, at block B330b.

In some embodiments, the second period of time may be the same as the first period of time. In some embodiments, the second period of time and the first period of time may have different time period lengths. In one example, the second period of time of waiting may be predefined to be, for example, but not limited to 30 seconds. In another example, the second period of time may change dynamically over time. For example, as more scans have been performed, the period of time of waiting may be lengthened. In yet another example, the period of time may be based, at least in part, on the type of mobile communication device 200 and/or parameters thereof. For example, a longer period of waiting time may be applied for a mobile communication device having a smaller dimension. In still another example, the period of time may be based on the component or thermal zone for which the temperature is high. For example, different periods of time may be applied to a situation in which the temperature of the memory 214 is high and a situation in which the temperature of the baseband modem processor 216 is high.

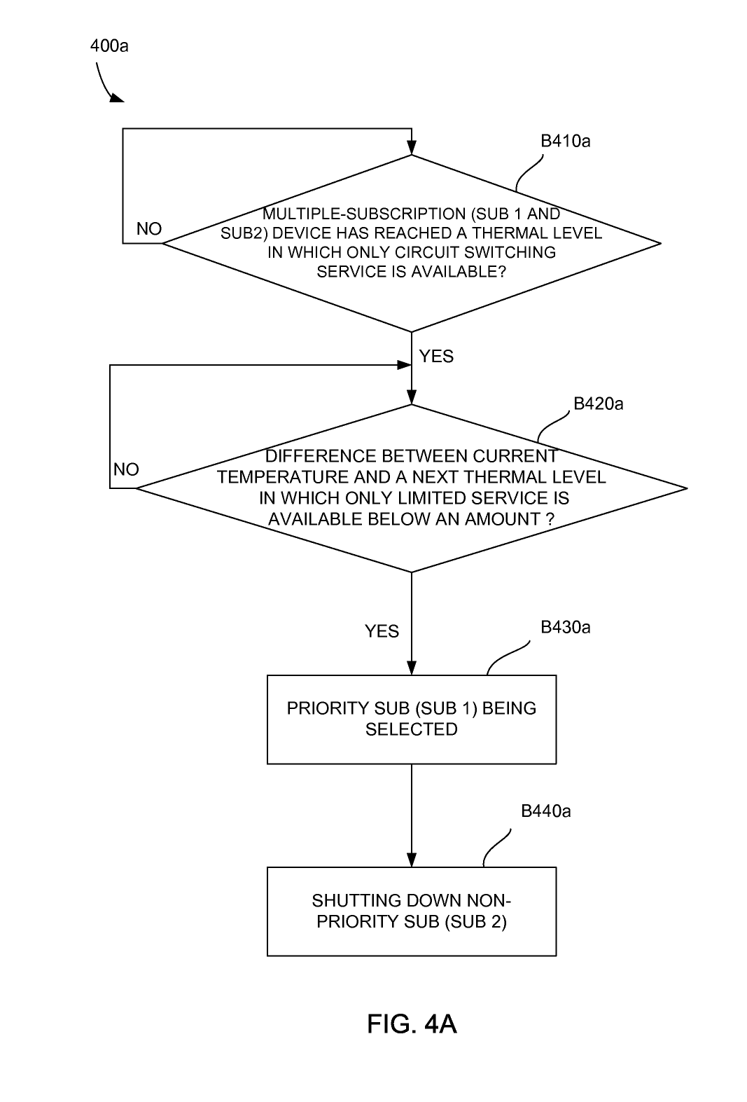

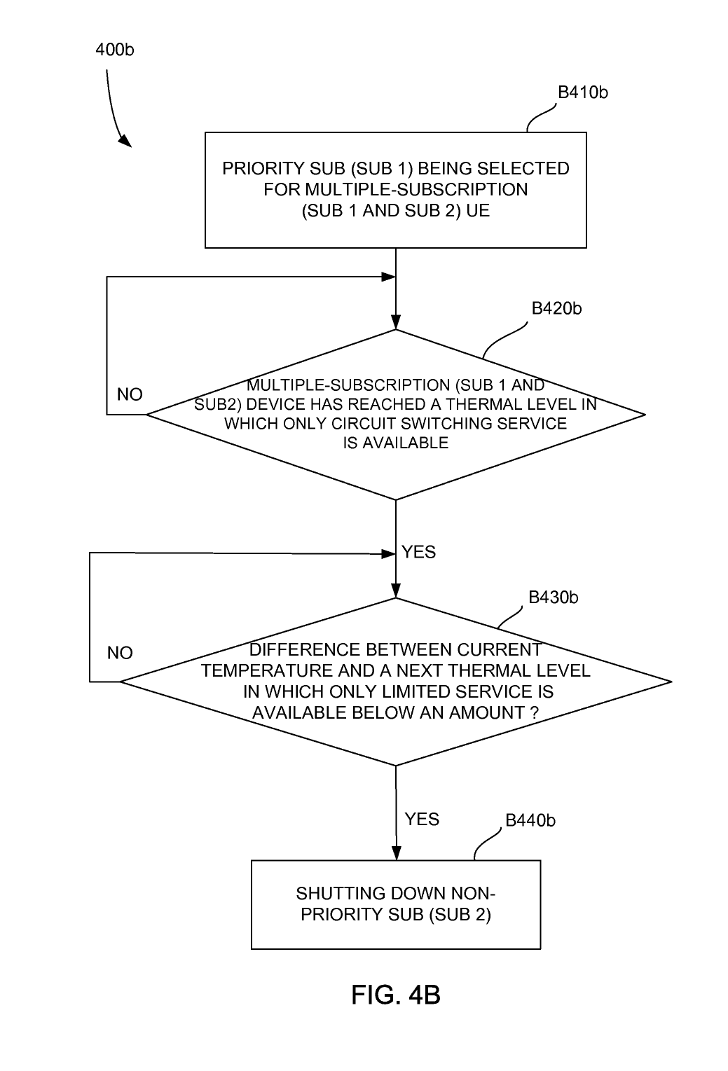

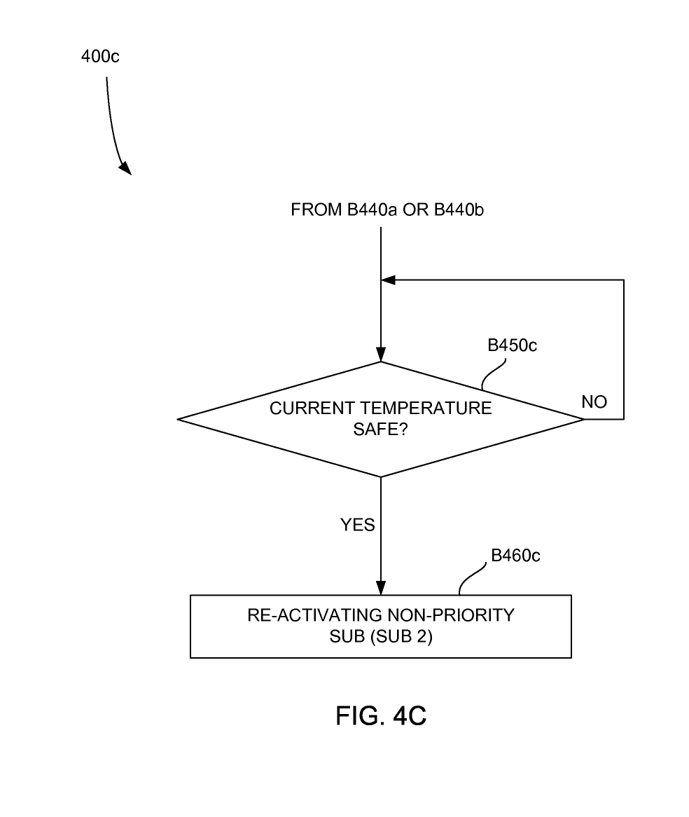

FIG. 4A is a process flowchart diagram illustrating an example of a thermal mitigation method 400a according to various embodiments. Referring to FIGS. 1-4A, the thermal mitigation method 400a may be performed by the thermal management unit 230 of the mobile communication device 200 according to some embodiments.

At block B410a, the thermal management unit 230 may determine whether the multi-subscription mobile communication device 200 has reached a thermal level in which only circuit switching (CS) service is available. Thus in response to determining that the mobile communication device 200 has not reached the thermal level (B410a: NO), the thermal management unit 230 may keep checking the temperature. In response to determining that the mobile communication device 200 has reached the thermal level (B410a: YES), the baseband modem processor 216 may determine whether a difference between the current temperature and a next thermal level in which only limited service is available below an amount, at block B420a. If the mobile communication device 200 has reached the thermal mitigation state in which only CS service is available, and the temperature continues to rise to a level in which the thermal mitigation action is to allow only emergency communications, some important voice calls might be dropped. Therefore, under such thermal conditions, the thermal management unit 230 according to particular embodiments may take actions before the next thermal level is reached. The thermal management unit 230 may decide to take actions if the difference between the current temperature and a next thermal level is below a predefined amount, for example, but not limited to, less than 2 Celsius degrees. Otherwise, the thermal management unit 230 may determine that the current temperature is not approaching the next level threshold and not take actions.

In response to determining that the difference is not below the amount (B420a: NO), the thermal management unit 230 may keep checking the temperature. In response to the thermal management unit 230 determining that the difference is below the amount (B420a: YES), the thermal management unit 230 may have a subscription (e.g., SUB 1) selected as a priority subscription, at block B430a. In particular embodiments, the thermal management unit 230 may issue an alert to a user, such as through the display 226, informing the user of the thermal state and requesting the user to select a priority subscription through the mobile communication device 200. In other embodiments, the priority subscription may be selected automatically based on the quality of the connection of each subscription (based on, for example, but not limited to a signal to noise ratio), historical usage of each subscription (such as, but not limited to which subscription has been used more), or other predefined factors. In other embodiments, the priority subscription may set in advance (e.g., refer to FIG. 4B).

Next, at block B440a, the thermal management unit 230 may shut down a non-priority subscription (e.g., SUB 2). In particular, when SUB 2 is in service, the second RF resource 218b exchanges information with the second base station 140 periodically via the second connection 142. When shut down, the second RF resource 218b no longer exchanges information with the second base station 140 and the power generated for SUB 2 may be reduced. As discussed above, in some embodiments, SUB 1 and SUB 2 may share a single RF resource, utilizing the RF resource in time slots assigned thereto. The time slots assigned to SUB 1 and SUB 2 may be fixed, or based on demand. SUB 2 may be shut down by stopping assigning time slots for SUB 2.

FIG. 4B is a process flowchart diagram illustrating an example of a thermal mitigation method 400b according to various embodiments. Referring to FIGS. 1-4B, the thermal mitigation method 400b may be performed by the thermal management unit 230 of the mobile communication device 200 according to some embodiments.

FIG. 4B is similar in certain manners to FIG. 4A except that the thermal mitigation method 400b involves having a priority SUB selected prior to determining that the mobile communication device 200 has reached a thermal level where only circuit switching service is available. In particular, at block B410b, the thermal management unit 230 may have a subscription (SUB 1) selected as a priority subscription. In particular, the thermal management unit 230 may issue a request through the display 226 asking the user to select a priority subscription, for example, but not limited to, at the time of entering of initial settings of the mobile communication device 200 or at another appropriate time. In other embodiments, the priority subscription may be selected automatically based on the quality of the connection of each subscription (such as, but not limited to, the signal to noise ratio of each subscription), historical usage of each subscription (such as, but not limited to, which subscription has been used more), or other predefined factors, and may be refreshed periodically.

Next, at block B420b, the thermal management unit 230 may determine whether the multi-subscription mobile communication device 200 has reached a thermal level where only circuit switching (CS) service is available.

Thus in response to determining that the mobile communication device 200 has not reached the thermal level (B420b: NO), the thermal management unit 230 may keep checking the temperature. In response to determining that the mobile communication device 200 has reached the thermal level (B420b: YES), the baseband modem processor 216 may determine whether a difference between the current temperature and a next thermal level in which only limited service is available below an amount, at block B430b. In response to determining that the difference is not below the amount (B430b: NO), the thermal management unit 230 may keep checking the temperature. In response to determining that the difference is below the amount (B430: YES), the thermal management unit 230 may shut down a non-priority subscription (e.g., SUB 2), at block 440b.

FIG. 4C is a process flowchart diagram illustrating an example of a thermal mitigation process according to various embodiments. Referring to FIGS. 1-4C, the thermal mitigation method 400c may be performed by the thermal management unit 230 of the mobile communication device 200 according to some embodiments.

The thermal mitigation method of 400c in FIG. 4C may have same operations as B410a-B440a and/or B410b-B440b as illustrated with reference to FIGS. 4A and/or 4B.

With reference to FIGS. 1-4C, at block 450c, the thermal management unit 230 may be configured to determine whether the current temperature has dropped to a predefined safe level. For example, if the predefined amount in B420a and/or B430b is 2 Celsius degrees, the safe level may be set as 4 Celsius degree lower than the next thermal level. In other embodiments, other suitable values may be selected for the predefined safe level. By setting a lower safe level, a repeating back and forth transition (or ping pong effect) between the states of “approaching” and “safe” may be avoided.

In response to determining that the current temperature has not dropped to the safe level (B450c: NO), the thermal management unit 230 may keep checking the temperature. In response to determining that the current temperature has dropped to the safe level (B450c: YES), the thermal management unit 230 may reactivate SUB 2. In particular, if dedicated RF resources 218a and 218b are used for SUB 1 and SUB 2 respectively, RF resource 218b associated with SUB 2 may be reactivated. If a single RF resource is shared by SUB 1 and SUB 2 based on time slots assigned to each, the baseband processor 216 may start to assign time slots for SUB 2 again. Time slots assigned to SUB 2 may be fixed or based on demand.

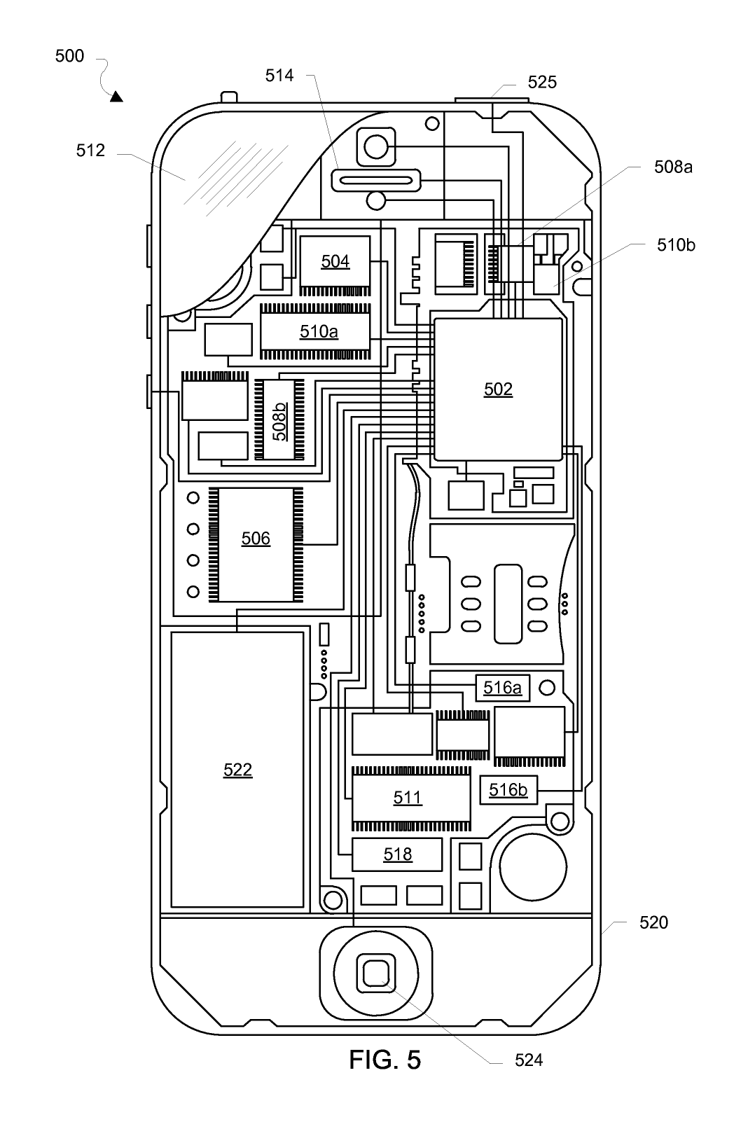

The various embodiments may be implemented in any of a variety of mobile communication device s, an example of which is illustrated in FIG. 5, as the mobile communication device 500, which may correspond to the mobile communication device 110, 200 in FIGS. 1-2. As such, the mobile communication device 500 may implement the process and/or the apparatus of FIGS. 1-4C, as described herein.

With reference to FIGS. 1-5, the mobile communication device 500 may include a processor 502 coupled to a touchscreen controller 504 and an internal memory 506. The processor 502 may be one or more multi-core integrated circuits designated for general or specific processing tasks. The memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile communication device 500 need not have touch screen capability.

The mobile communication device 500 may have one or more cellular network transceivers 508a, 508b coupled to the processor 502 and to two or more antennae 510 and configured for sending and receiving cellular communications. The transceivers 508 and antennae 510a, 510b may be used with the above-mentioned circuitry to implement the various embodiment methods. The cellular network transceivers 508a, 508b may be the RF resources 218a, 218b, respectively. The antennae 510a, 510b may be the wireless antenna 220a, 220b. The mobile communication device 500 may include two or more SIM cards 516a, 516b, corresponding to SIM-1 204a and SIM-2 204b, coupled to the transceivers 508a, 508b, and/or the processor 502. The mobile communication device 500 may include a cellular network wireless modem chip 511 (e.g., the baseband processor 216) that enables communication via a cellular network and is coupled to the processor.

The mobile communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to a peripheral device connection port (not shown) to receive a charging current from a source external to the mobile communication device 500. The mobile communication device 500 may also include a physical button 524 for receiving user inputs. The mobile communication device 500 may also include a power button 526 for turning the mobile communication device 500 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Various modifications to embodiments described herein will be readily apparent to those skilled in the art, and the generic principles defined herein may be applied to some embodiments without departing from the spirit or scope of the disclosure. Thus, the present disclosure is not intended to be limited to the embodiments shown herein but is to be accorded the widest scope consistent with the following claims and the principles and novel features described herein.

1. A method for performing thermal mitigation in a mobile communication device having a first subscription and a second subscription, comprising:
determining whether the mobile communication device has reached a first thermal level in which only circuit switching services are available;
detecting that the second subscription is out of service in response to determining that the mobile communication device has reached the first thermal level;
determining whether a current temperature exceeds, beyond a threshold, a temperature at a time of a previous scan for an available network for the second subscription; and
waiting a first period of time before scanning for the available network for the second subscription, in response to determining that the current temperature exceeds, beyond the threshold, the temperature at the time of the previous scan.

2. The method of claim 1, wherein waiting the first period of time comprises waiting until the current temperature does not exceed, beyond the threshold, the temperature at the time of the previous scan.

3. The method of claim 1, further comprising:
scanning for the available network for the second subscription in response to determining that the temperature after waiting the first period of time does not exceed, beyond the threshold, the temperature at the time of the previous scan.

4. The method of claim 3, further comprising:
determining that the available network has been found; and
connecting the second subscription to the available network.

5. The method of claim 3, further comprising:
determining that the available network has not been found; and
waiting a second period of time before scanning for the available network for the second subscription.

6. The method of claim 3, wherein scanning for the available network comprises scanning a frequency band for detecting a broadcast signal transmitted by a base station of the available network.

7. The method of claim 1, wherein the first period of time is a predefined period of time.

8. The method of claim 1, wherein the first period of time changes dynamically over time.

9. The method of claim 1, wherein the first period of time is based, at least in part, on a type of the mobile communication device or parameters thereof.

10. The method of claim 1, wherein the first period of time is based, at least in part, on a component or a thermal zone for which the current temperature exceeds, beyond the threshold, the temperature at the time of the previous scan.

11. The method of claim 1, further comprising:
determining whether a difference between the current temperature of the mobile communication device and a second thermal level in which only emergency services are available is below an amount;
selecting the first subscription as a priority subscription; and
shutting down the second subscription, but not the first subscription, in response to determining that the difference is below the amount.

12. The method of claim 11, wherein shutting down the second subscription comprises shutting down a radio frequency (RF) resource dedicated to use by the second subscription.

13. The method of claim 11, wherein shutting down the second subscription comprises stopping assigning time slots of a radio frequency (RF) resource for the second subscription, and wherein the RF resource is shared by the first subscription and the second subscription based on time slots already assigned.

14. The method of claim 11, further comprising:
determining whether the current temperature has dropped to a predefined level, after shutting down the second subscription; and
reactivating the second subscription in response to determining that the current temperature has dropped to the predefined level.

15. The method of claim 1, wherein the previous scan is a last scan for the available network for the second subscription before determining the current temperature.

16. A mobile communication device having a first subscription and a second subscription, comprising:
at least one radio frequency (RF) resource;
one or more processors coupled to the RF resource and configured with processor-executable instructions to:
determine whether the mobile communication device has reached a first thermal level in which only circuit switching services are available;
detect that the second subscription is out of service in response to determining that the mobile communication device has reached the first thermal level;
determine whether a current temperature exceeds, beyond a threshold, a temperature at a time of a previous scan for an available network for the second subscription; and
wait a first period of time before scanning for the available network for the second subscription, in response to the determining that the current temperature exceeds, beyond the threshold, the temperature at the time of the previous scan.

17. The mobile communication device of claim 16, further comprising one or more thermal sensors communicably coupled to the one or more processors, wherein the one or more thermal sensors are configured to detect the current temperature of at least a portion of the mobile communication device.

18. The mobile communication device of claim 16, wherein the one or more processors are further configured with processor-executable instructions to:
scan for the available network for the second subscription in response to determining that the temperature after waiting the first period of time does not exceed, beyond the threshold, the temperature at the time of the previous scan.

19. The mobile communication device of claim 18, wherein the one or more processors are further configured with processor-executable instructions to:
determine whether the available network has been found;
connect the second subscription to the available network, in response to determining that the available network has been found; and
wait a second period of time before scanning for the available network for the second subscription, in response to determining that the available network has not been found.

20. A method for performing thermal mitigation in a mobile communication device having a first subscription and a second subscription, comprising:
determining whether the mobile communication device has reached a first thermal level in which only circuit switching services are available;
determining whether a difference between a current temperature of the mobile communication device and a second thermal level in which only emergency services are available is below an amount, in response to determining that the mobile communication device has reached the first thermal level;
selecting the first subscription as a priority subscription; and
shutting down the second subscription, but not the first subscription, in response to determining that the difference is below the amount.

21. The method of claim 20, wherein selecting the first subscription as the priority subscription comprises receiving a user input from the mobile communication device corresponding to a user's selection of the first subscription as the priority subscription.

22. The method of claim 20, wherein shutting down the second subscription comprises shutting down a radio frequency (RF) resource dedicated to use by the second subscription.

23. The method of claim 20, wherein shutting down the second subscription comprises stopping assigning time slots of a radio frequency (RF) resource for the second subscription, wherein the RF resource is shared by the first subscription and the second subscription based on time slots already assigned.

24. The method of claim 20, further comprising:
determining whether the current temperature has dropped to a predefined level, after shutting down the second subscription; and
reactivating the second subscription in response to determining that the current temperature has dropped to the predefined level.

25. The method of claim 24, wherein reactivating the second subscription comprises reactivating a radio frequency (RF) resourced dedicated to use by the second subscription.

26. The method of claim 24, wherein reactivating the second subscription comprises starting to assign time slots of a radio frequency (RF) resource for the second subscription, and wherein the RF resource is shared by the first subscription and the second subscription based on time slots already assigned.

27. A mobile communication device having a first subscription and a second subscription, comprising:
at least one radio frequency (RF) resource;
one or more processors coupled to the RF resource and configured with processor-executable instructions to:
determine whether the mobile communication device has reached a first thermal level in which only circuit switching services are available;
determine whether a difference between a current temperature of the mobile communication device and a second thermal mitigation state in which only emergency services are available is below an amount, in response to determining that the mobile communication device has reached the first thermal level;
select the first subscription as a priority subscription; and
shut down the second subscription, but not the first subscription, in response to determining that the difference is below the amount.

28. The mobile communication device of claim 27, further comprising one or more thermal sensors communicably coupled to the one or more processors, wherein the one or more thermal sensors are configured to detect the current temperature of at least a portion of the mobile communication device.

29. The mobile communication device of claim 27, wherein the one or more processors are further configured with processor-executable instructions to:
shut down the second subscription comprises shutting down a radio frequency (RF) resource dedicated to use by the second subscription.

30. The mobile communication device of claim 27, wherein the one or more processors are further configured with processor-executable instructions to:
stop assigning time slots of a radio frequency (RF) resource for the second subscription, wherein the RF resource is shared by the first subscription and the second subscription based on time slots already assigned.
